(19) United States
(12) Patent Application Publication
(10) Pub. No.: US 2002/0004414 A1
(43) Pub. Date: Jan. 10, 2002

(54) Remote control unit for a mobile telephone, and mobile telephone controllable by a remote control unit

(76) Inventors: Arnaud Rosay, Le Mans (FR); Jean-Michel Simon, Le Mans (FR)

Correspondence Address: U.S Philips Corporation, 580 White Plains Road, Tarrytown, NY, 10591, US

(21) Appl. No.: 09/861,935

(22) Filed: May 21, 2001

(30) Foreign Application Priority Data
May 30, 2000 (FR) 0006946

(51) Int. Cl. H04M 1/00

(52) U.S. Cl. 455/566; 455/575

(57) ABSTRACT

The invention relates to a remote control unit (1) for a mobile telephone (2) and to a mobile telephone (2) which is controllable by a remote control unit (1).

The remote control unit (1) comprises a transmitter for transmitting, to the mobile telephone (2), a signal (S2) comprising data entered from a keyboard (3), a receiver for receiving a signal (S3) comprising data coming from the mobile telephone (2) and a display module (4) for displaying the data entered from the keyboard (3) or the data comprised in the signal (S3) received by the receiver.

The mobile telephone (2) comprises a receiver for receiving a signal (S2) comprising data entered from the keyboard (3) of the remote control unit (1) and a transmitter for retransmitting, to the remote control unit (1), data comprised in a signal (S1) which it receives.

### DESCRIPTION

The invention relates to a remote control unit for a mobile telephone and to a mobile telephone which is controllable by a remote control unit.

The invention finds a particularly advantageous application in the remote control of a mobile telephone installed beyond the user's reach. It may be, for example, the remote control of the mobile telephone installed in a vehicle.

When a mobile telephone is installed in a vehicle, for example, a motorcar, it generally occupies a position which does not allow the driver to use it easily. Dialing telephone numbers and, more generally, any handling to be performed with the mobile telephone are delicate operations that may endanger driving of the vehicle.

Currently, there is no remote control module for a mobile telephone. It is an object of the invention to provide such a module which can solve the above-mentioned drawbacks.

To this end, the invention relates to a remote control unit for a mobile telephone. The remote control unit comprises a keyboard of alphanumerical characters for entering data, a transmitter for transmitting a signal comprising said data to the mobile telephone, a receiver for receiving a signal comprising data coming from the mobile telephone, and a display module for partly or fully displaying the data entered from the keyboard or the data comprised in the signal received by the receiver.

The invention also relates to a mobile telephone comprising a keyboard of alphanumerical characters for entering data and a display module for displaying the data entered from the keyboard as well as data comprised in a signal received by the mobile telephone. The mobile telephone comprises a receiver for receiving a signal comprising data entered from the keyboard of a remote control unit and a transmitter for retransmitting, to the remote control unit, the data comprised in the signal which it receives.

The invention also relates to a system constituted by a remote control unit and a mobile telephone. The remote control unit is a unit according to the invention, and the mobile telephone is a telephone according to the invention.

The invention also relates to a motorcar vehicle comprising a steering wheel. The vehicle comprises a support fixed to the wheel for accommodating a remote control unit according to the invention.

These and other aspects of the invention are apparent from and will be elucidated, by way of non-limitative example, with reference to the embodiments described hereinafter.

In the drawings:

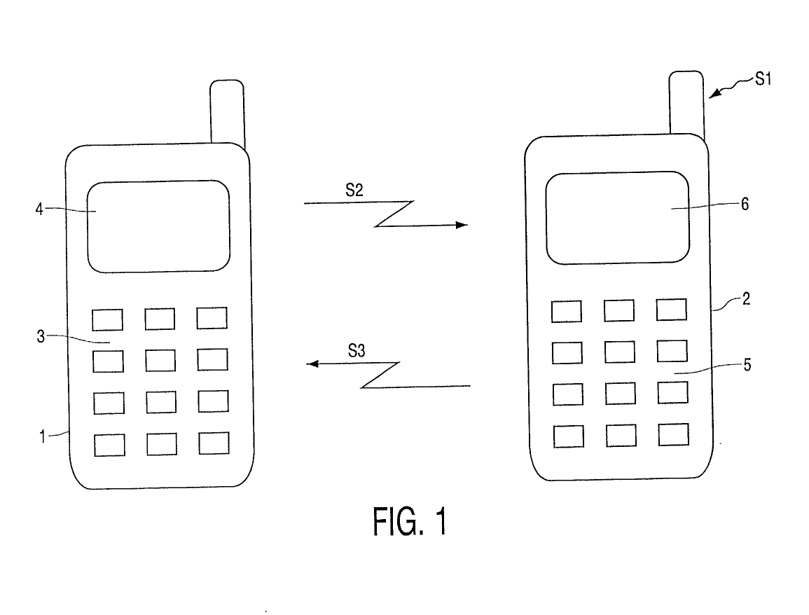

FIG. 1 shows a transmitting/receiving system constituted by a remote control unit and a mobile telephone according to the invention.

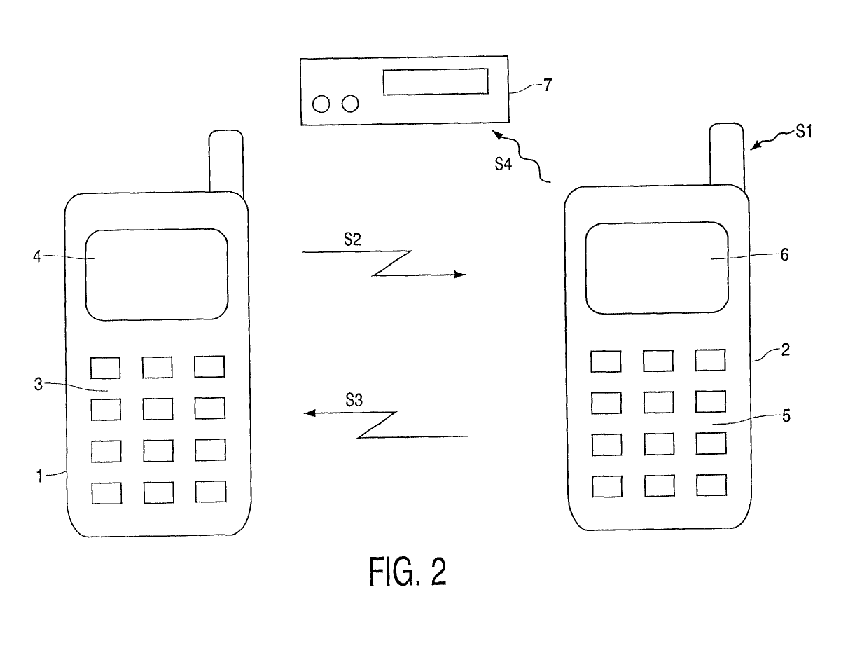

FIG. 2 shows an improved embodiment of the system shown in FIG. 1.

In all Figures, identical reference signs denote identical components.

FIG. 1 shows a transmitting/receiving system constituted by a remote control unit and a mobile telephone according to the invention.

The system comprises a remote control unit 1 which is reversible to a mobile telephone and a mobile telephone 2 which is reversible to a remote control unit. The remote control unit 1 comprises, inter alia, an alphanumerical keyboard 3, a display screen 4, a transmitter circuit (not shown) and a receiver circuit (not shown). The mobile telephone comprises, inter alia, an alphanumerical keyboard 5, a display screen 6, a transmitter circuit (not shown) and a receiver circuit (not shown).

The data entered from the keyboard 3 and transmitted by the transmitter of the remote control unit are transmitted to the mobile telephone 2 via a signal S2. In accordance with the preferred embodiment of the invention, the keyboard of the remote control unit is identical to the keyboard of the mobile telephone. Consequently, pressing or releasing a key of the keyboard of the remote control unit has the same effects on the mobile telephone as when performing these operations on the mobile telephone directly.

For display on the screen of the remote control unit 1, the receiver circuit of the remote control unit allows reception of data comprised in a signal S3 coming from the mobile telephone 2. The data comprised in the signal S3 come from a signal S1 received by the mobile telephone 2. Moreover, the signal S1 comprises audio data processed in known manner by a receiver circuit of the mobile telephone 2.

In accordance with a first embodiment of the invention, the signals S2 and S3 exchanged between the remote control unit 1 and the mobile telephone 2 are infrared signals. The transmitters of the remote control unit and the mobile telephone thus comprise electroluminescent diodes for transmitting the signals S2 and S3. The directivity of the signals S2 and S3 can be improved by using lenses. In accordance with the preferred embodiment of the invention, the IrDA (“Infrared Data Association”) protocol is used for the exchange of data between the remote control unit and the mobile telephone. As is known to those skilled in the art, the IrDA protocol consists of a layer protocol for infrared connections as defined by the Infrared Data Association. Advantageously, the use of the IrDA protocol allows re-establishing of interrupted communications during a short time interval.

In accordance with a second embodiment of the invention, the transmitters and receivers operate at transmission frequencies used in data radiocommunication systems generally referred to as RDS systems (RDS stands for “Radio Data System”). In the latter case, the signals S2 and S3 exchanged between the remote control unit 1 and the mobile telephone 2 are constituted by a subcarrier modulated at, for example, 57 kHz.

When applying the invention to the control of a mobile telephone installed in a motorcar vehicle, the remote control unit may be placed on a support within the driver's reach. This support may be installed, for example, on the steering wheel of the vehicle.

FIG. 2 shows an improved embodiment of the system shown in FIG. 1.

In accordance with this embodiment, the audio data comprised in the signal S1 received by the mobile telephone 2 are retransmitted to the radio receiver 7 of the vehicle. The loudspeaker of the mobile telephone 2 may then be disconnected. The audio data are transmitted by a signal S4 modulated at a frequency which is suitable for reception by the radio receiver 7.

1. A remote control unit (1) for a mobile telephone (2), characterized in that it comprises a keyboard (3) of alphanumerical characters for entering data, a transmitter for transmitting a signal comprising said data to the mobile telephone (2), a receiver for receiving a signal comprising data coming from the mobile telephone (2), and a display module (4) for partly or fully displaying the data entered from the keyboard (3) or the data comprised in the signal received by the receiver.

2. A remote control unit (1) as claimed in claim 1, characterized in that the signal (S2) transmitted by the transmitter and the signal (S3) received by the receiver are infrared signals.

3. A remote control unit (1) as claimed in claim 2, characterized in that the transmitter comprises an electroluminescent diode.

4. A remote control unit (1) as claimed in claim 2 or 3, characterized in that the exchange of data between the remote control unit (1) and the mobile telephone (2) is effected in accordance with the IrDA (“Infrared Data Association”) protocol.

5. A remote control unit (1) as claimed in claim 1, characterized in that the signal (S3) received by the receiver and the signal (S2) transmitted by the transmitter have a frequency which is chosen from the frequencies of useful signals in data radiocommunication systems.

6. A remote control unit (1) as claimed in claim 5, characterized in that the signal (S3) received by the receiver and the signal (S2) transmitted by the transmitter are signals whose frequency is modulated at 57 kHz.

7. A mobile telephone (2) comprising a keyboard (5) of alphanumerical characters for entering data and a display module (6) for displaying the data entered from the keyboard (5) as well as data comprised in a signal (S1) received by the mobile telephone (2), characterized in that it comprises a receiver for receiving a signal comprising data entered from the keyboard (3) of a remote control unit and a transmitter for retransmitting, to the remote control unit (1), the data comprised in the signal (S1) which it receives.

8. A mobile telephone (2) as claimed in claim 7, characterized in that the signal (S2) received by the receiver and the signal (S3) transmitted by the transmitter are infrared signals.

9. A mobile telephone (2) as claimed in claim 8, characterized in that the transmitter comprises an electroluminescent diode.

10. A mobile telephone (2) as claimed in claim 7, characterized in that the signal (S2) received by the receiver and the signal (S3) transmitted by the transmitter have a frequency which is chosen from the frequencies of useful signals in data radiocommunication systems.

11. A mobile telephone (2) as claimed in claim 10, characterized in that the signal (S2) received by the receiver and the signal (S3) transmitted by the transmitter are signals whose frequency is modulated at 57 kHz.

12. A mobile telephone (2) as claimed in any one of claim 10 or 11, characterized in that it comprises a transmitter for retransmitting, to a radio receiver (7), audio data comprised in a signal (S1) which it receives.

13. A system constituted by a remote control unit (1) as claimed in claim 2 and a mobile telephone (2) as claimed in claim 8.

14. A system constituted by a remote control unit (1) as claimed in claim 5 and a mobile telephone (2) as claimed in claim 10.

15. A system as claimed in any one of claim 13 or 14, characterized in that the keyboard of the remote control unit (1) is identical to the keyboard of the mobile telephone (2).

16. A motorcar vehicle comprising a steering wheel, characterized in that it comprises a support fixed to the wheel for accommodating a remote control unit (1) as claimed in any one of claims 1 to 6.
